(19) United States
(12) Patent Application Publication
(10) Pub. No.: US 2025/0206954 A1
(43) Pub. Date: Jun. 26, 2025

(54) WATER HYACINTH FIBER-BASED MATERIALS

(71) Applicant: IN-BETWEEN INTERNATIONAL, Watermael-Boitsfort (BE)

(72) Inventors: Rebeka BAHADORANI, Bruxelles (BE); Richard THOMMERET, Kraainem (BE)

(21) Appl. No.: 18/849,080

(22) PCT Filed: Mar. 20, 2023
(86) PCT No.: PCT/EP23/57039

§ 371 Date: Sep. 20, 2024

(30) Foreign Application Priority Data
Mar. 22, 2022 (US) 17701210

(51) Int. Cl. C08L 97/02; C08L 99/00

(52) U.S. Cl. CPC C08L 97/02; C08L 99/00; C08L 2201/06; C08L 2203/12; C08L 2203/30; C08L 2205/03; C08L 2205/16; C08L 2312/00

(57) ABSTRACT

A material includes a water hyacinth fiber and a substance mixed with the water hyacinth fiber. The substance is not polyurethane. A concentration of the substance in the material is in a range of 0 to 20%. The present invention is also related to a method for preparing a material including water hyacinth fibers.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present disclosure relates to water hyacinth fiber-based materials, for example, a material including a water hyacinth fiber mixed with a substance.

### 2. Description of Related Art Including Information Disclosed Under 37 CFR 1.97 and 37 CFR 1.98.

Water hyacinth, or “Eichhornia crassipes,” is a freshwater aquatic plant. The plant may have a water content in a range of 90 to 98% and the rest is dry matter. The dry matter of plant may include, among other components, about 45% cellulose, about 15% hemicellulose, and about 2.5% lignin. A calorific value of the plant may be in a range of 14 to 15 MJ/kg, which is close to that of wood. The water hyacinth fibers may be defibrated using techniques such as a hammer mill, a disc mill, or the like. A humidity level for the defibration may be in a range of 5 to 25%. The defibration allows the length and width of the water hyacinth fibers to be adapted from a dried plant.

### BRIEF SUMMARY OF THE INVENTION

According to one embodiment, a material is disclosed. The material may include a water hyacinth fiber. The material may further include a substance mixed with the water hyacinth fiber. The substance may not be polyurethane. A concentration of the substance in the material may be in a range of 0 to 20%. The concentration of the substance in the mixture is preferably comprised between 5 and 15%, yet more preferably equal to 10%, considering the total weight of the mixture.

According to another embodiment, a method for preparing a material including water hyacinth fibers is disclosed. The method may include mixing a water hyacinth with a substance, resulting a mixture of the water hyacinth fiber and the substance. The substance may not be polyurethane. A concentration of the substance in the mixture may be in a range of 0 to 20%. The method may further include heating the mixture at a temperature. The method may also include pressing the mixture under a pressure over a time period. The method may further include cooling the mixture, resulting in the formation of the material.

According to yet another embodiment, a product including water hyacinth fibers is disclosed. The product may include a material that further includes a water hyacinth fiber and a substance mixed with the water hyacinth fiber. The substance may not be polyurethane. A concentration of the substance in the material may be in a range of 0 to 20%. The concentration of the substance in the material is preferably comprised between 5 and 15%, yet more preferably equal to 10%, considering the total weight of the material.

### BRIEF DESCRIPTION OF THE SEVERAL VIEWS OF THE DRAWINGS

FIG. 1A is a perspective view depicting one embodiment of a product in a form of a plate.

FIG. 1B is a perspective view depicting another embodiment of a product in a form of a disk.

FIG. 1C is a perspective view depicting yet another embodiment of a product in a form of a pot.

FIG. 1D is a perspective view depicting still yet another embodiment of a product in a form of a pellet.

FIG. 2A is a schematic view depicting an exemplary long water hyacinth fiber according to one embodiment of the present disclosure.

FIG. 2B is a photo illustrating depicting an exemplary short water hyacinth fiber according to another embodiment of the present disclosure.

FIG. 2C is a schematic view depicting an exemplary very fine water hyacinth fiber according to yet another embodiment of the present disclosure.

FIG. 3 is a schematic view depicting an exemplary block diagram illustrating a method for preparing the material as described herein.

### DETAILED DESCRIPTION OF THE INVENTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Aspects of the present disclosure relate to water hyacinth fiber-based materials, for example, a material including a water hyacinth fiber mixed with a substance. More preferably, the water hyacinth fiber-based materials or products according to the present invention are 100% biobased and/or 100% biodegradable or compostable.

The incorporation of the substance into the water hyacinth fiber may enhance the physical and/or mechanical properties of the water hyacinth fiber. The material may be used to manufacture a product. The presence of the substance in the water hyacinth fiber may thus also enhance the physical and/or mechanical properties of the product. Some of the physical and/or mechanical properties include rigidity, tensile strength, impact resistance, and water resistance (i.e. waterproofing).

Some examples of the product may include an insulation material (e.g. for buildings), a packaging material (e.g. for food), a liquid-absorption material, a pot (e.g. for gardening), a cushioning material (e.g. for transportation), a kitchen accessory, or the like. Particularly, the liquid-absorption material may be a cat litter or any other materials that absorb water, oil (e.g. petrol), and/or oil derivatives (e.g. gasoline, white spirit, or oil for automobiles). A concentration of the substance in the material may be in a range of 0 to 20%. The concentration of the substance in the material is preferably comprised between 5 and 15%, yet more preferably equal to 10%, considering the total weight of the material.

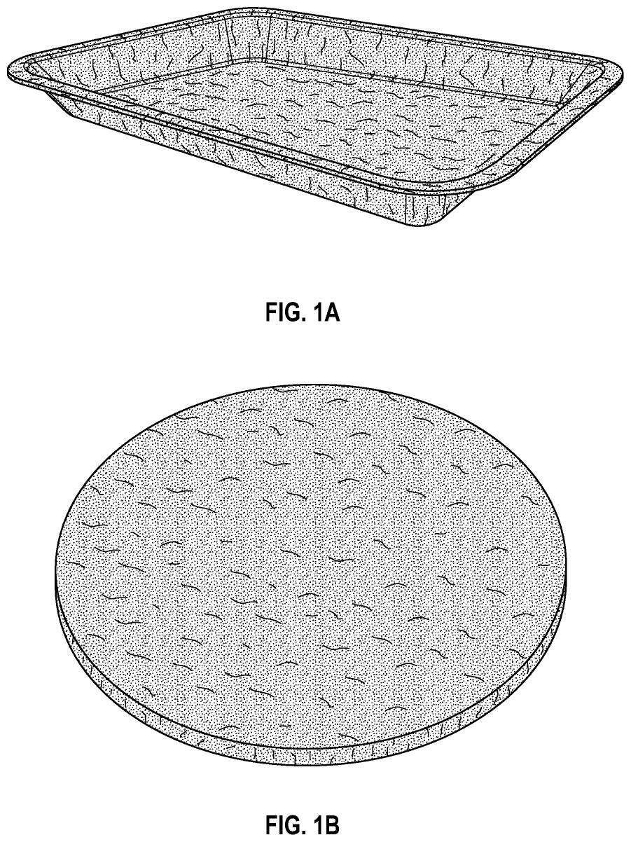

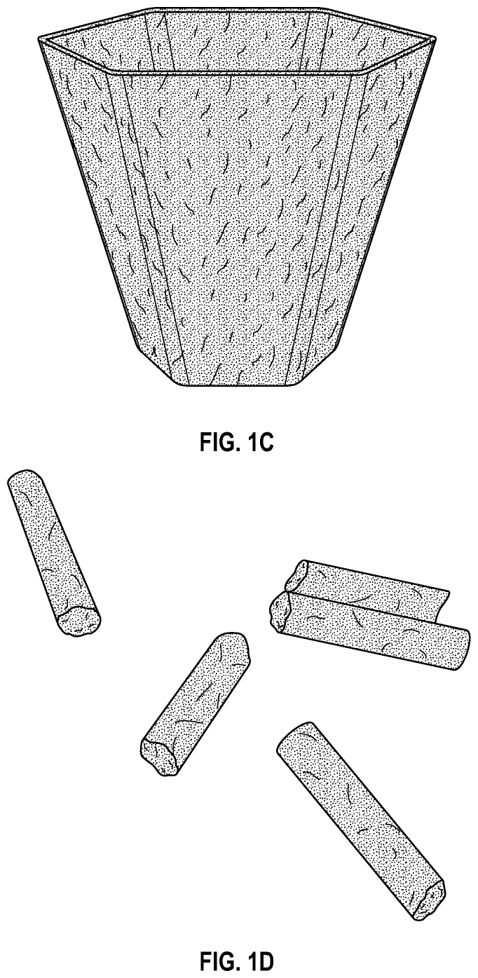

FIGS. 1A to ID depict exemplary products manufactured using the material described herein. Specifically, FIG. 1A depicts one embodiment of a product in a form of a plate. FIG. 1B depicts another embodiment of a product in a form of a disk. FIG. 1C depicts yet another embodiment of a product in a form of a pot. FIG. 1D depicts still yet another embodiment of a product in a form of a pellet. It is contemplated that the product may also be in any other desired forms in addition to those illustrated in FIGS. 1A to ID.

Methods for harvesting and processing water hyacinth fibers are described in U.S. application Ser. No. 16/315,811, the disclosure of which is hereby incorporated by reference in its entirety. The length and width of the water hyacinth fibers may vary depending on an intended application of the water hyacinth fibers and/or the appearance of a desired finished product. The water hyacinth fibers may have a single or a binomial type size distribution.

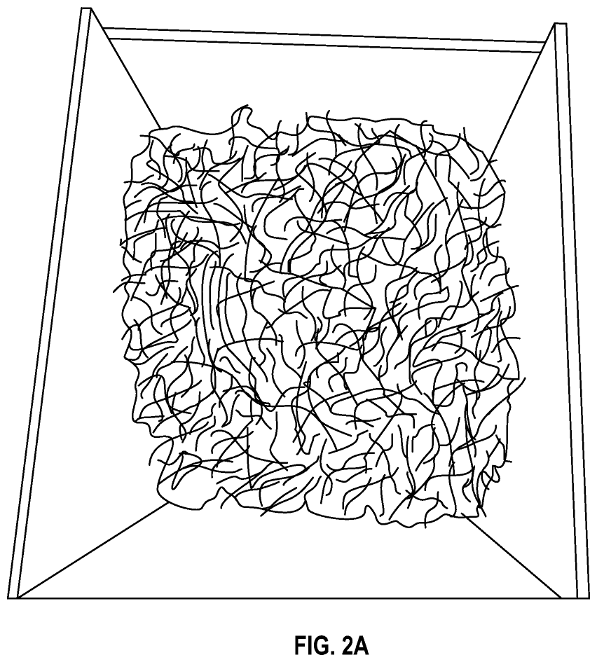

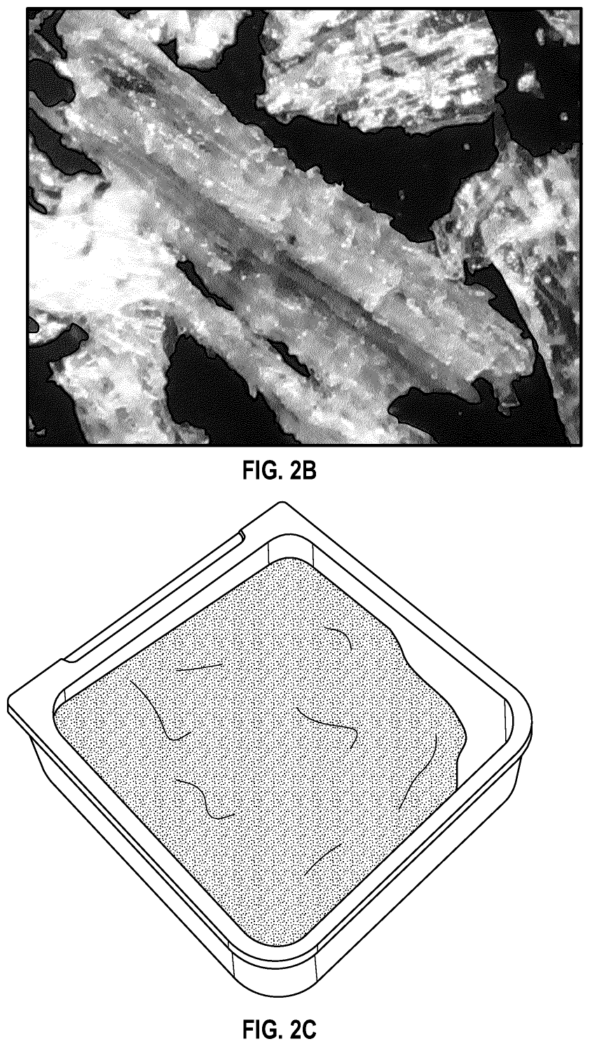

FIG. 2A depicts an exemplary long water hyacinth fiber according to one embodiment of the present disclosure. For a long fiber, the length of the fiber may be in a range of 10 millimeter (mm) to 100 mm, and the width of the fiber may be in a range of 1 mm to 10 mm, or any other desirable length and width. Specifically, the long water hyacinth fiber shown in FIG. 2A may have a length of about 25 mm.

FIG. 2B depicts an exemplary short water hyacinth fiber according to another embodiment of the present disclosure. For a short fiber, the length of the fiber may be in a range of 2 mm to 10 mm, and the width of the fiber may be in a range of 0.1 mm to 1 mm, or any other desirable length and width. Specifically, FIG. 2B shows a short water hyacinth fiber taken under a microscope, where the short water hyacinth fiber may have a length of about 5 mm.

FIG. 2C depicts an exemplary very fine water hyacinth fiber according to yet another embodiment of the present disclosure. For a very fine fiber (e.g. flour), the length of the fiber may be in a range of 100 micrometer (pm) to 2 mm, and the width of the fiber may be in a range of 25 pm to 150 pm, or any other desirable length and width. Specifically, the very fine water hyacinth fiber shown in FIG. 2C may have a length of about 2 mm.

According to a first embodiment of the present disclosure, the substance may be a thermoplastic. Some examples of the thermoplastic may include polyethylene (PE), polypropylene (PP), polyvinyl chloride (PVC), polystyrene (PS), acrylonitrile butadiene styrene (ABS), styrene acrylonitrile (SAN), acrylonitrile styrene acrylate (ASA), poly(methyl methacrylate) PMMA, polycarbonate (PC), polylactic acid (PLA), and polyhydroxyalkanoate (PHA). PE may be high-density PE (HDPE), low-density PE (LDPE), or linear low-density PE (LLDPE) cellulose acetate and polycaprolactone. PS may be high-impact PS (HIPS).

PLA, PHA and polycaprolactone are particularly preferred additives due to their melting temperature, their biobased origin and degradability. Particularly, the melting temperature of PLA is around 175° C., the melting temperature of PHA is comprised between 4° and 180° C., the melting temperature of cellulose acetate is around 60-70° C.

According to a second embodiment of the present disclosure, the substance may be a thermoset. Some examples of the thermoset may include polyesters, epoxides, aminoplasts, phenoplasts, and ureaformaldehyde.

According to a third embodiment of the present disclosure, the substance may be an elastomer. Some examples of the elastomer may include thermoplastic elastomers (TPE), styrene-butadiene-styrene (SBS), ethylene-vinyl acetate (EVA), rubber, polyisoprene, and silicones.

According to a fourth embodiment of the present disclosure, the substance may be an additive. Some examples of the additive may include a binding agent, a hydrophobic agent, a flame retardant, a fiber protection agent, a perfume, an aroma, a pigment, and a dye.

Specifically, the binding agent may include an oxygen group. In some embodiments, the binding agent may react with a free hydroxyl group (—OH) in the water hyacinth fiber, and some examples of the binding agent may include methylene diphenyl diisocyanate (MDI), toluene diisocyanate (TDI), formic acid, and acetic acid. In other embodiments, the binding agent may be a glue-type substance, and some examples of the binding agent may include starch, paraffin, polycyclopentadiene, polyethylene terephthalate (PET), and PP.

The hydrophobic agent may include, but not limited to, wax, carnauba, calendula, bee wax or soya beans wax, and paraffin. The combination of a hydrophobic agent with water hyacinth fibers is particularly interesting for manufacturing products, for example pots, for use in plant cultivation, in particular when the products must be immersed for a more or less long period in water, or be in contact with water or wet soil.

The flame retardant may include, but not limited to, ammonium polyphosphate and sulphate.

For some very specific applications, the fiber protection agent may include, but not limited to, permethrin, organic copper compounds, and pesticides, chosen among the list of substances authorized by the various regulations. In some embodiments, the pesticides may be organochlorine pesticides, including, but not limited to, aldrin, chlordane, dichlorodiphenyldichloroethane (DDD), dichlorodiphenyldichloroethylene (DDE), dichlorodiphenyltrichloroethane (DDT), dichlofluanid, dieldrin, endrin, heptachlor, hexach-lorobenzene, lindane, and pentachlorophenol. In some other embodiments, the pesticides may be organophosphate pesticides, including, but not limited to, dimethoat, fenthion, parathion-methyl, parathion-ethyl, and phosalon. In yet some other embodiments, the pesticides may be pyrethroids, including, but not limited to, cypermethrin, lambda-cyhalothrin, and permethrin. The pesticides may further be benomyl, carbendazim, or prochloraz. The fiber protection agent may act against insects, mold, microorganisms, rodents, or the like. It is however preferable to use biodegradable and/or biosourced fiber protection agents, or additives, as water hyacinths are not put in contact with pesticides or insecticides from the chemical industry during their growth.

According to a fifth embodiment of the present disclosure, the water hyacinth fibers are mixed with other vegetable fibers to enhance the mechanical properties of the material. Especially, wood fibers can be added to water hyacinth fibers, and the concentration of wood fibers is in a range of 0 to 20%, more particularly in a range of 5 to 15%. More particularly, the combination of wood fibers with water jacinth fibers improved the mechanical properties of a material in terms of traction, compression, flexion, and modulus of rigidity.

Instead of woods fibers, or in addition with those fibers, the water hyacinth fibers can be mixed with other vegetable fibers selected in the group consisting of hemp fibers, miscanthus fibers, flax fibers, coconut fibers, sisal fibers.

Here it is the entanglement of the vegetable fibers, which will be bound together, that will give enhanced properties.

The water hyacinth fibers may also be mixed with any cellulosic material, such as paper fibers, or agricultural waste such as corn.

According to a sixth embodiment of the present disclosure, the substance may be a combination of any of the thermoplastic, the thermoset, the elastomer, the other vegetable fibers, and the additive as described herein. In that case, the concentration of the combination of the additives is in a range of 0 to 20%.

More preferably, in such case, the concentration of the combination of the additives in the mixture is preferably comprised between 5 and 15%, yet more preferably equal to 10%, considering the total weight of the mixture.

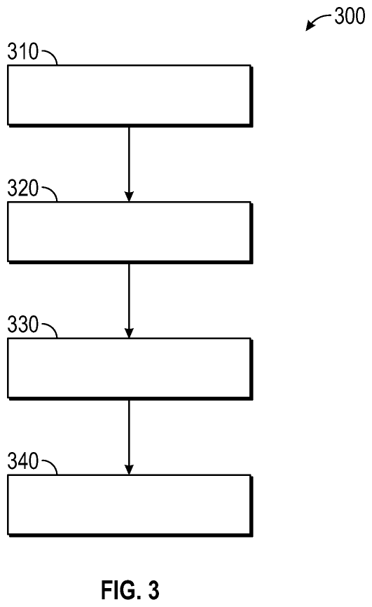

According to one or more embodiments of the present disclosure, a method for preparing a material including water hyacinth fibers is described. FIG. 3 depicts an exemplary block diagram illustrating a method 300 for preparing the material as described herein. The material may be prepared by mixing a water hyacinth fiber with a substance. The water hyacinth fiber may have a single or a binomial type size distribution. The water hyacinth fiber may be a long fiber, with a length of the fiber in a range of 10 mm to 100 mm and a width of the fiber in a range of 1 mm to 10 mm, or any other desirable length and width. The water hyacinth fiber may be a short fiber, with a length of the fiber in a range of 2 mm to 10 mm and a width of the fiber in a range of 0.1 mm to 1 mm, or any other desirable length and width. The water hyacinth fiber may be a very fine fiber, with a length of the fiber in a range of 100 μm to 2 mm and a width of the fiber in a range of 25 μm to 150 μm, or any other desirable length and width.

The substance may be a thermoplastic, a thermoset, an elastomer, an additive, or any combination thereof. Specifically, the thermoplastic may be PE, PP, PVC, PS, ABS, SAN, ASA, PMMA, PC, PLA, or PHA. PE may be HDPE, LDPE, or LLDPE. PS may be HIPS. The thermoset may be polyesters, epoxides, aminoplasts, phenoplasts, and urea formaldehyde (UF). The elastomer may be TPE, SBS, EVA, rubber, polyisoprene, or silicones. The additive may be a binding agent, a hydrophobic agent, a flame retardant, a fiber protection agent, a perfume, an aroma, a pigment, or a dye. The binding agent may include an oxygen group. In some embodiments, the binding agent may react with a free hydroxyl group (—OH) in the water hyacinth fiber, and some examples of the binding agent may include MDI, TDI, formic acid, and acetic acid. In some other embodiments, the binding agent may be a glue-type substance, and some examples of the binding agent may include starch, paraffin, polycyclopentadiene, PET, and PP. The hydrophobic agent may include, but not limited to, wax, carnauba, calendula, bee or soya beans, and paraffin.

The substance may also be other vegetable fibers selected in the group consisting of wood fibers, hemp fibers, miscanthus fibers, flax fibers, coconut fibers, sisal fibers.

For some very specific applications, the fiber protection agent may include, but not limited to, permethrin, organic copper compounds, and pesticides. In some embodiments, the pesticides may be organochlorine pesticides, including, but not limited to, aldrin, chlordane, DDD, DDE, DDT, dichlofluanid, dieldrin, endrin, heptachlor, hexach-lorobenzene, lindane, and pentachlorophenol. In some other embodiments, the pesticides may be organophosphate pesticides, including, but not limited to, dimethoat, fenthion, parathion-methyl, parathion-ethyl, and phosalon. In yet some other embodiments, the pesticides may be pyrethroids, including, but not limited to, cypermethrin, lambda-cyhalothrin, and permethrin. The pesticides may further be benomyl, carbendazim, or prochloraz. The fiber protection agent may act against insects, mold, microorganisms, rodents, or the like.

Referring to FIG. 3, the present invention is also related to a method of manufacturing a material including water hyacinth fibers. It is understood that the material based on water hyacinth fibers can be obtained by carrying out this process.

The method 300 includes a thermoforming process, which utilizes both heating and pressure techniques during the preparation of the material. Specifically, at step 310, the method 300 may include mixing a water hyacinth fiber with a substance, resulting a mixture of the water hyacinth fiber and the substance. A concentration of the substance in the mixture may be in the range of 0 to 20%.

Indeed, the inventors discovered that, surprisingly, by heating and applying pressure to a material based on water hyacinth fibers, possibly including an additive, it was possible to manufacture objects from these fibers, said objects thus obtained having satisfactory mechanical properties.

The concentration of the substance in the mixture is preferably comprised between 5 and 15%, yet more preferably equal to 10%, considering the total weight of the mixture. Indeed, it has been determined that a proportion of the additive substance higher than 5% enhances the reinforcement and mechanical properties of a final product obtained with such mixture.

When a substance is mixed with the vegetal fibers, PLA, PHA and polycaprolactone are particularly preferred additives due to their melting temperature, their biobased origin and degradability. Particularly, the melting temperature of PLA is around 175° C., the melting temperature of PHA is comprised between 4° and 180° C., the melting temperature of cellulose acetate is around 60-70° C.

Consequently, at step 320, the method 300 further includes heating a water hyacinth fiber at a temperature.

The heating temperature in the thermoforming process of water hyacinth fibers must be higher than 70° C. Indeed, at a temperature above 70° C., the lignin contained in the water hyacinth fibers decomposes and consequently acts as a kind of glue to improve the mechanical properties of the water hyacinth fiber-based material finally obtained.

On the other hand, the heating temperature in the thermoforming process of water hyacinth fibers must remain at or below 220° C. Indeed, at a temperature higher than 220° C., the degradation of the fiber begins and can go as far as decomposition and leads to a change of color, turning from beige to brown and there is a significant loss of mechanical properties.

Preferably, the heating temperature in the thermoforming process may be in a range of 120 to 220° C. Possible effects of the heating at such range of heating temperature may be that: when the temperature is above 120° C., hemicellulose in the water hyacinth fiber may begin decomposing (e.g. undergoing hydrolysis), generating at least one kind of sugar and releasing acetic acid; and when the temperature reaches around 160° C., the acetic acid may catalyze the degradation of lignin in the water hyacinth fiber. Free radicals may appear on lignin chains to trigger crosslinking via polycondensation reactions with other components in the cell walls of the water hyacinth fiber, resulting in:
reinforcement of the rigidity of the aggregated water hyacinth fibers
gluing the water hyacinth fibers together
these compounds (sugars, degradated lignin . . . ) act as binding materials.

Thus, yet more preferably, the heating temperature in the thermoforming process according to the invention is comprised between 17° and 200° C.

At step 330, the method 300 may also include pressing the mixture under a pressure over a time period. The pressure may be in a range of 0.1 to 10 bars, typically around 1 bar. The time period for pressing the mixture may vary depending on a desired thickness of the material.

In some embodiments, the time period of applying a pressure to the mixture may be in a range of 10 seconds(s) to 3 minutes (min) or, preferably, in a range to 20 s to Imin. The mixture may be pressed using a double plate press, and a temperature of each plate of the double plate press may be controlled collectively or independently.

At step 340, the method 300 may further include cooling the mixture after pressing, resulting in the formation of the material including the water hyacinth fiber mixed with the substance. A thickness of the material may be in a range of 1 mm to 5 mm or any other desired thickness. The thickness of the material may vary depending on the pressure applied to the mixture at step 330 and/or an initial amount of the water hyacinth fiber used in the thermoforming process. In some embodiments, the material may include at least one layer of the water hyacinth fiber. Because the material is porous, vacuum may not be needed in the preparation of the material.

Due to the presence of the substance, the material may exhibit an enhanced physical and/or mechanical properties compared to the water hyacinth fiber alone. The material may be used to manufacture a product, including, but not limited to, an insulation material (e.g. for buildings), a packaging material (e.g. for food), a liquid-absorption material, a pot (e.g. for gardening), a cushioning material (e.g. for transportation), a kitchen accessory (e.g. meal trays or dish plates), or the like. Particularly, the liquid-absorption material may be a cat litter or any other materials that absorb water, oil, (e.g. petrol) and/or oil derivatives (e.g. gasoline, white spirit, or oil for automobiles). The product may be in a form of a plate, a disk, a pot, a pellet, or the like, as shown in FIGS. 1A to ID.

In addition to the thermoforming process described herein, the material may also be prepared using other techniques, including, but not limited to, extrusion, injection, and calendaring.

The process of making products from water hyacinth fibers is particularly interesting. Indeed, contrary to the processes of the state of the art for the manufacturing of products based on vegetable fibers, which are particularly energy consuming, the process of the invention is very energy efficient. In particular, it does not require the implementation of a drying step and uses little or no water.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Note that, when relevant, the characteristics that have been described in the present application in relation to water hyacinth fiber-based material are applicable to the manufacturing process, and vice versa.

We claim:

1. A material comprising:
a water hyacinth fiber; and
a substance mixed with the water hyacinth fiber, wherein the substance is not polyurethane, and a concentration of the substance in the material is in a range of 0 to 20%.

2. The material of claim 1, wherein the concentration of the substance mixed with the water hyacinth fiber is in a range of 5 to 15%.

3. The material of claim 1, wherein the substance is a thermoplastic, a thermoset, an elastomer, an additive, vegetables fibers, or a combination thereof.

4. The material of claim 3, wherein the thermoplastic is selected from the group consisting of polyethylene (PE), polypropylene (PP), polyvinyl chloride (PVC), polystyrene (PS), acrylonitrile butadiene styrene (ABS), styrene acrylonitrile (SAN), acrylonitrile styrene acrylate (ASA), poly(methyl methacrylate) PMMA, polycarbonate (PC), and biodegradable or compostable thermoplastic selected from the group consisting of polylactic acid (PLA), and polyhydroxyalkanoate (PHA) and polycaprolactone.

5. The material of claim 3, wherein the thermoset is selected from the group consisting of polyesters, epoxides, aminoplasts, phenoplasts, and urea formaldehydes.

6. The material of claim 3, wherein the elastomer is selected from the group consisting of thermoplastic elastomers (TPE), styrene-butadiene-styrene (SBS), ethylene-vinyl acetate (EVA), rubber, polyisoprene, and silicones.

7. The material of claim 3, wherein the additive is selected from the group consisting of a binding agent, a hydrophobic agent, a flame retardant, a fiber protection agent, a perfume, an aroma, a pigment, and a dye.

8. The material of claim 7, wherein the binding agent includes an oxygen group.

9. The material of claim 7, wherein the binding agent is selected from the group consisting of methylene diphenyl diisocyanate (MDI), toluene diisocyanate (TDI), formic acid, and acetic acid.

10. The material of claim 7, wherein the binding agent is selected from the group consisting of starch, paraffin, polycyclopentadiene, polyethylene terephthalate (PET), and PP, and
wherein the hydrophobic agent is selected from the group consisting of wax, carnauba, calendula, bee wax, soya beans wax, and paraffin.

11. (canceled)

12. The material of claim 7, wherein the fiber protection agent is selected from the group consisting of permethrin, organic copper compounds, and pesticides.

13. The material of claim 1, wherein the substance is vegetable fibers selected in the group consisting of wood fibers, hemp fibers, miscanthus fibers, flax fibers, coconut fibers, sisal fibers.

14. A method for preparing a material including water hyacinth fibers, the method comprising the steps of:
mixing a water hyacinth fiber with a substance, resulting a mixture of the water hyacinth fiber and the substance, wherein the substance is not polyurethane, and a concentration of the substance in the mixture is in a range of 0 to 20%;
heating the mixture at a temperature in a range of 70 to 220° C.,
wherein the step of heating further comprises:
decomposing the water hyacinth fibers;
generating at least one kind of sugar;
releasing acetic acid; and
gluing the water hyacinth fibers together with the at least one kind of sugar;
pressing the mixture under a pressure in a range of 0.1 to 10 bars over a time period comprised between 10 seconds to 3 minutes; and
cooling the mixture.

15. The method of claim 14, wherein the heating temperature is comprised between 12° and 200° C., and
wherein the step of heating further comprises:
catalyzing the degradation of lignin with the released acetic acid; and
cross-linking free radicals on lignin chains in cell walls of the fiber via polycondensation reactions so as to reinforce rigidity of the water hyacinth fibers.

16. The method of claim 14, wherein the concentration of the substance in the mixture is in a range of 5 to 15%.

17. The method of claim 14, wherein the mixture is pressed using a double plate press, and wherein a temperature of each plate of the double plate press is controlled collectively or independently.

18. The method of claim 14, wherein a thickness of the material is in a range of 1 mm to 5 mm.

19. The method of claim 14, wherein the material includes at least one layer of the water hyacinth fiber.

20. A product, comprising:
a material being comprised of a water hyacinth fiber and a substance mixed with the water hyacinth fiber, wherein the substance is not polyurethane, and a concentration of the substance in the material is in a range of 0 to 20%.

21. The product of claim 20, wherein the material is is a plate, a disk, a pot, or a pellet.
